(19) United States
(12) Patent Application Publication
(10) Pub. No.: US 2012/0229083 A1
(43) Pub. Date: Sep. 13, 2012

(54) HANDHELD TOOL BATTERY CHARGING MEANS

(76) Inventors: Wolf Matthias, Stuttgart (DE); Gunter Flinspach, Leonberg (DE); Alexander Osswald, Stuttgart (DE); Rainer Glauning, Leinfelden-Echterdingen (DE); Tobias Hans, Stuttgart (DE)

(21) Appl. No.: 13/395,719

(22) PCT Filed: Jul. 28, 2010
(86) PCT No.: PCT/EP2010/060945

§ 371 Date: May 24, 2012

(30) Foreign Application Priority Data
Sep. 14, 2009 (DE) 102009029411.2

(51) Int. Cl. H02J 7/00

(52) U.S. Cl. 320/108

(57) ABSTRACT

A handheld tool battery charging unit, e.g., for a handheld machine tool battery, has at least one battery accommodation region and at least one detachable battery contact unit provided to be connected to at least one battery pack, as well as at least one charging connection element provided for receiving energy transmitted in a wireless manner.

### BACKGROUND OF THE INVENTION

1. Field of the Invention

The present invention relates to a handheld tool battery charging unit.

2. Description of Related Art

Handheld tool battery charging unit, e.g., for a handheld machine tool battery, having at least one battery accommodation region and at least one detachable battery contact means, provided to be connected to at least one battery unit, has been proposed before.

### BRIEF SUMMARY OF THE INVENTION

It is proposed that the handheld tool battery charging means have at least one charging connection means, provided for receiving energy transmitted in a wireless manner. By “battery contact means” one should understand especially means that, in an operation-ready state, produce at least one electrical contact to a battery unit. The battery contact means are preferably provided for exchanging energy with a battery unit bidirectionally, that is, for charging and discharging it. In an operation-ready state, the battery contact means provides a permanent mechanical connection to the battery unit. By “detachable contact means” one should especially understand a contact means which produces a connection that is detachable from an operator electrically and especially mechanically. The connection is advantageously detachable without using a tool. By the term “battery pack” one should understand particularly a device having an energy store, which is provided particularly to supply a motor of an handheld machine tool with electrical energy. The energy store is advantageously developed as at least one battery cell that appears useful to one skilled in the art, and particularly as a lithium battery cell. The energy store device is advantageously developed as a rechargeable battery pack.

By “provided” one should understand particularly specially designed and/or specially equipped. By “charge connecting means” one should understand particularly means that receive energy, at least during operation, using which in particular the battery contact means, in at least one operating state, charges at least one battery pack. The charge connecting means advantageously receives energy having a power of at least 10 Watt, advantageously at least 100 Watt, particularly advantageously at least 500 Watt. By “wireless charge connecting means” one should understand particularly charge connecting means that receives energy which has been transmitted by at least one electrically nonconductive medium, i.e. by a material having a specific resistance of more than 0.1 Ω·mm²/m, advantageously more than 1 Ω·mm²/m, particularly advantageously more than 10 Ω·mm²/m. The wireless charge connecting means advantageously receives energy transmitted according to the eCoupled Standard, i.e. energy that is transmitted inductively. The energy transmission is monitored, in this context, by a monitoring electronics system.

Alternatively and/or additionally, the wireless charge connecting means could receive capacitive energy, electromagnetic energy and/or mechanical energy. Because of the embodiment according to the present invention of the handheld tool battery charging means, means may be provided, simple in design and cost-effective, by which a usual battery pack is able to be charged using energy that is advantageously transmitted in a wireless manner, whereby in particular great safety and great comfort can be achieved. The handheld tool battery charging means is advantageously developed as an handheld tool battery charging adapter, particularly advantageously as an handheld machine tool battery charging adapter.

In a further embodiment, it is provided that the handheld tool battery charging means have at least one detachable machine contact means provided to transmit energy to an handheld machine tool. By “machine contact means” one should understand especially means that, in at least one operation state, produce at least one electrical contact to an handheld machine tool. In an operation-ready state, the machine contact means also provides a permanent, in particular detachable mechanical connection to the handheld machine tool. By “handheld machine tool” one should understand all handheld machine tools appearing useful to one skilled in the art, that are provided to be operated using a battery pack, such as, in particular, drilling machines, drilling hammers, sawing machines, planing machines, electric screwdrivers, portable milling machines, portable grinding machines, multifunctional machines and/or particularly drilling screwdrivers. By “transmit” one should particularly understand, in this connection, that the machine contact means forward energy from the battery pack to the handheld machine tool. By the use of the detachable machine contact means, the handheld tool battery charging means may be connected advantageously between the battery pack and the handheld machine tool. Because of that, the handheld tool battery charging means are able to be combined with particularly many different types of battery packs that are common in the trade, in which machine contact means and a charging energy input are partially developed in one piece. A handheld machine tool and a battery pack which is provided to be connected directly to the handheld machine tool, may advantageously remain unchanged for use with the handheld tool battery charging means.

Furthermore, it is provided that the battery contact means and the machine contact means be developed in complementary fashion, whereby the handheld tool battery charging means are able to be combined with a battery pack, which may also be connected directly to the handheld machine tool. This means that an original battery pack may advantageously be retrofitted to the handheld tool battery charging means. By the phrase “developed in complementary fashion” one should particularly understand that the battery contact means and the machine contact means form two counterparts of a contact means system that match each other, especially a plug connection. The battery contact means of the handheld tool battery charging means is provided to be connected to a machine contact means of the battery pack. The machine contact means of the handheld tool battery charging means is provided to be connected to a battery contact means of the handheld machine tool.

It is also provided that the charging connecting means have an energy receiving coil. By “energy receiving coil” one should particularly understand a coil provided to convert inductively transmitted energy to electrical energy. Because of the energy receiving coil, particularly high power is able to be received in a simple design, cost-effectively and having a low installation space requirement.

In addition, it is provided that the machine contact means have a protective device that is provided to prevent energy absorption from a wire-bound charging device. In particular, by “protective device” one should understand in this connection a device which prevents by an electrically, and/or advantageously mechanically acting means that a wire-bound charging unit, in at least one operating state, such as during a charging process via the charging connecting means, transmits energy to the machine contact means. The machine contact means of the handheld tool battery charging means preferably has an additional electrical and/or particularly mechanical element, compared to the machine contact means of the battery pack. By “energy absorption” one should understand particularly an energy transmission from a third element to the machine contact means of the handheld tool battery charging means. By “wire-bound charging unit” one should particularly understand a charging unit that is provided to transmit energy to a battery pack via a conductive contact, during a charging process. A charging unit has in particular at least one voltage transformer. The protective device is advantageously able to prevent that the handheld tool battery charging means charges the battery pack, especially simultaneously with an energy from a wire-bound charging unit and energy received from the charge connecting means, whereby such a faulty operation is able to be avoided and damage to the battery pack is able to be prevented.

In one advantageous development of the present invention it is provided that the protective device is provided in order to prevent the contacting of the wire-bound charging unit, whereby a particularly cost-effective and simply designed protective device may be achieved. By the phrase “prevent the contacting” one should particularly understand that the protective device mechanically prevents an electric connection of the wire-bound charging unit to the machine contact means, especially via a spatial embodiment of an housing of the handheld tool battery charging means.

Another development provides for the handheld tool battery charging means to have a monitoring electronics system that is provided to monitor at least one charging process. By a “monitoring electronics system” one should understand especially an electronics system that monitors a voltage, a current and/or a temperature of the battery pack, at least during a charging process. The monitoring electronics system advantageously influences the charging process, at least as a function of one of these characteristic quantities. Because of the monitoring electronics system, the service life of the battery pack is able to be advantageously prolonged and, in particular, damage to the battery pack avoided.

Furthermore, it is provided that the handheld tool battery charging means have a connection element that is provided to connect, particularly mechanically, at least one of the contact means and the charging connecting means, situated on at least two different sides of the battery accommodation region. By “at least one of the contact means” one should understand especially the machine contact means and/or the battery contact means. The two different sides are advantageously at least at a distance of 2 cm from each other and/or are situated on opposite sides of the battery accommodation region. Because of the connecting element, a particularly advantageous positioning can be achieved of the charging connecting means relatively to at least one of the contact means, especially when the battery pack is to be charged separately from the handheld machine tool.

Moreover, it is provided that the charging connecting means be provided to enclose an handheld machine tool at least partially, whereby an especially advantageous positioning of the charging connecting means, particularly if the battery pack is to be charged when connected to the handheld machine tool. By the phrase “enclose at least partially” one should understand in particular that the charging connecting means has a concave accommodating region.

In addition, the present invention relates to a system having an handheld tool battery charging means, a battery pack and especially an handheld machine tool, whereby components of the system are able to be adjusted to one another particularly advantageously.

It is provided that the handheld tool battery charging means are provided to remain connected to the battery pack when the battery pack is separated from the handheld machine tool, whereby the battery pack is able to be charged in a wireless manner, particularly comfortably, and separated from the handheld machine tool. By the phrase “when it is separated” one should particularly understand a time period which begins with a separation of the battery pack from the handheld machine tool and ends at the latest with the connection of the battery pack to the handheld machine tool.

In one advantageous development of the present invention, it is provided that the handheld tool battery charging means are provided to remain connected to the battery pack after the battery pack is separated from the handheld machine tool, whereby the battery pack is able to be charged particularly comfortably, in a wireless manner, connected to the handheld machine tool.

### BRIEF DESCRIPTION OF THE DRAWINGS

FIG. 1 shows a system according to the present invention having an handheld tool battery charging means, which has a charging connecting means that is situated on a battery pack.

FIG. 2 shows a second exemplary embodiment of the handheld tool battery charging means of FIG. 1 having a charging connecting means which is situated on an handheld machine tool.

FIG. 3 shows a third exemplary embodiment of the handheld tool battery charging means of FIG. 1, having a charging connecting means which enclose an handheld machine tool.

### DETAILED DESCRIPTION OF THE INVENTION

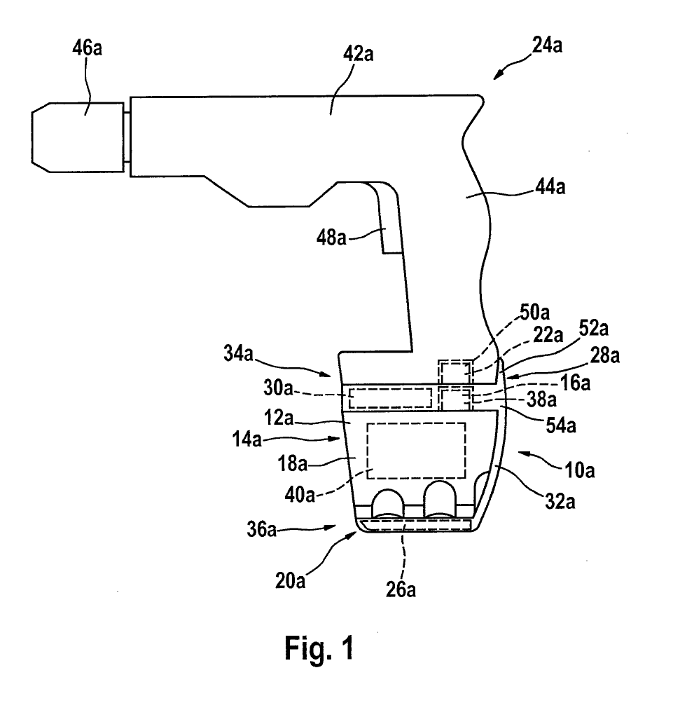

FIG. 1 shows a system having an handheld tool battery charging means 10a, having a battery pack 18a and having an handheld machine tool 24a. Battery pack 18a is developed as an handheld machine tool battery 12a. Battery pack 18a has detachable machine contact means 38a and an energy store 40a having a plurality of lithium ion battery cells that are not shown in greater detail. Handheld machine tool 24a is developed as a battery drilling screwdriver. It has a pistol-shaped housing 42a having a grip 44a, having an insertable tool fastening 46a, an operating element 48a and battery contact means 50a. Grip 44a is situated on the side of handheld machine tool 24a facing away from insertable tool fastening 46a. On one side of grip 44a, which points in the direction of insertable tool fastening 46a, there is an operating element 48a which is provided to control a motor, that is not shown in greater detail, of handheld machine tool 24a.

Handheld tool battery charging means 10a is connected to grip 44a, in a shown operation-ready state, at the end of grip 44a facing away from operating element 48a, at which battery contact means 50a of handheld machine tool 24a is situated. Handheld tool battery charging means 10a has a battery accommodation region 14a, a detachable battery contact means 16a, a charging connecting means 20a and a detachable machine contact means 22a. Using machine contact means 22a, handheld tool battery charging means 10a is connected mechanically and electrically to battery contact means 50a of handheld machine tool 24a, in a manner separable by an operator. During an operation of handheld machine tool 24a, machine contact means 22a transmits energy to handheld machine tool 24a. In addition, machine contact means 22a could transmit a characteristic quantity of the state of battery pack 18a, especially a characteristic quantity that described the temperature of battery pack 18a.

As seen from machine contact means 22a, behind battery contact means 16a there is situated battery accommodation region 14a. In battery accommodation region 14a, battery pack 18a is applied in the operation-ready state. Detachable battery contact means 16a of handheld tool battery charging means 10a connects handheld tool battery charging means 10a, that is separable by an operator, mechanically and electrically to machine contact means 38a of battery pack 18a. Battery contact means 16a could also transmit a characteristic quantity of a state of battery pack 18a.

Battery contact means 16a of handheld tool battery charging means 10a and battery contact means 50a of handheld machine tool 24a are complementary to machine contact means 22a of handheld tool battery charging means 10a and machine contact means 38a of battery pack 18a. Battery contact means 16a, 50a are developed as the female part of a plug connection. Machine contact means 22a, 38a are developed as the male part of a plug connection.

During a charging process, charging connecting means 20a receives energy transmitted wirelessly. A charge connecting station of the system, that is not shown in greater detail, emits this energy during a charging process. Charging connecting means 20a has an energy receiving coil 26a. Energy receiving coil 26a is developed as a coil having a ferrite core that is not shown in greater detail. A coil of the charging connecting station and energy receiving coil 26a in common form a resonance circuit in the operation-ready state.

Machine contact means 22a has a protective device 28a. Protective device 28a prevents that, because of a faulty operation, handheld tool battery charging means 10a takes up energy from a wire-bound charging unit. Protective device 28a has a projection 52, which is formed onto an housing 54a of handheld tool battery charging means 10a. Projection 52a prevents an operator from contacting handheld tool battery charging means 10a mechanically with a wire-bound charging unit that is not shown in greater detail, which is provided for charging battery pack 18a. Furthermore, protective device 28a has electronic components, that are not shown in greater detail, which prevent a current flow into machine contact means 22a of handheld tool battery charging means 10a. At least one of the electronic components is developed as a diode.

In addition, handheld tool battery charging means 10a has a monitoring electronics system 30a. Monitoring electronics system 30a ends a charging process when a provided charging state, i.e. a provided charging voltage of battery pack 18a has been reached.

In addition, handheld tool battery charging means 10a has a connecting element 32a. Connecting element 32a connects battery contact means 16a and machine contact means 22a inseparably mechanically and electrically to charging connecting means 20a. Contacting means 16a, 22a and charging connecting means 20a are situated on two opposite sides 34a, 36a of battery accommodation region 14a. Connecting element 32a is developed to be partially elastically deformable for inserting battery pack 18a.

When the operator separates battery pack 18a from handheld machine tool 24a, handheld tool battery charging means 10a remains connected to battery pack 18a in a standard operation, that is, when he exchanges battery pack 18a, the operator separates handheld tool battery charging means 10a from handheld machine tool 24a.

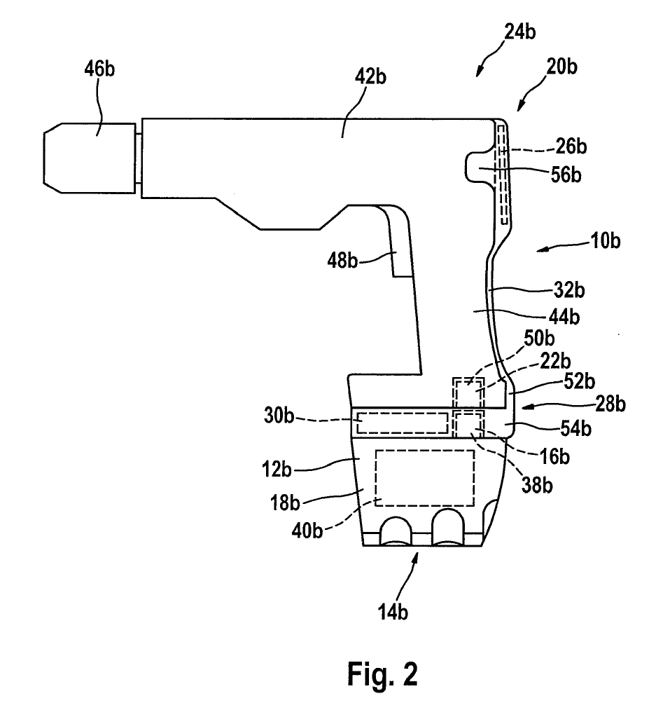

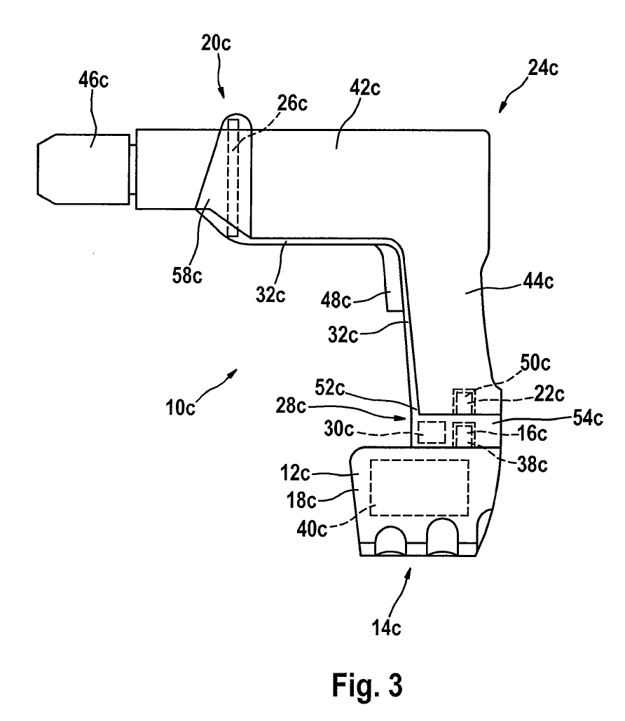

FIGS. 2 and 3 show two additional exemplary embodiments of the present invention. In order to distinguish the exemplary embodiments, the letter a in the reference symbols of the exemplary embodiment in FIG. 1 is replaced by the letters b and c in the reference symbols of the exemplary embodiment in FIGS. 2 and 3. The subsequent descriptions are essentially limited to the differences between the exemplary embodiments, reference being made to the description of the other exemplary embodiment, in particular of FIG. 1, with regard to components, features and functions that remain unchanged.

FIG. 2 shows a system having an handheld tool battery charging means 10b, a battery pack 18b and an handheld machine tool 24b. Handheld machine tool 24b has a pistol-shaped housing 42b and an insertable tool fastening 46b. Handheld tool battery charging means 10b has a battery accommodation region 14b, a detachable battery contact means 16b and charging connecting means 20b. Battery contact means 16b is connected electrically conductively to battery pack 18b, in a state of battery pack 18b ready for charging. Charge connecting means 20b receives energy transmitted wirelessly, during a charging process.

In an operation-ready state, charging connecting means 20b is situated on a side of housing 42b facing away from insertable tool fastening 46b. Charging connecting means 20b has latching elements 56b which connect charging connecting means 20b to housing 42b of handheld machine tool 24b. Latching elements 56b are latched into ventilation slots, not shown in greater detail, of handheld machine tool 24b. Handheld tool battery charging means 10b remains connected to handheld machine tool 24b when there is an exchange of battery pack 18b.

FIG. 3 shows a system having an handheld tool battery charging means 10c, a battery pack 18c and an handheld machine tool 24c. Handheld machine tool 24c has a pistol-shaped housing 42c and an insertable tool fastening 46c. Handheld tool battery charging means 10c has a battery accommodation region 14c, a detachable battery contact means 16c and charging connecting means 20c. In a state ready for charging of battery pack 18c, charging contacting means 16c is connected electrically conductively to battery pack 18c. During a charging process, charging connecting means 20c receives energy transmitted wirelessly.

Charging connecting means 20c encloses housing 42c of handheld machine tool 24c in one plane, in a region facing insertable tool fastening 46c. For this purpose, charging connecting means 20c has an essentially disk-shaped accommodating region 58c for the handheld machine tool. Accommodating region 58c is bordered by a concave surface of charging connecting means 20c A connection element 32c of handheld tool battery charging means 10c extends, on a side facing insertable tool fastening 46c of handle 44c of handheld machine tool 24c, and in the direction of insertable tool fastening 46c between battery contact means 16c and accommodating region 58c.

1-13. (canceled)

14. A handheld-tool battery charging apparatus, comprising:
at least one battery accommodation region;
at least one detachable battery contact unit configured to be connected to at least one battery pack; and
at least one charging connection unit configured to receive wirelessly transmitted energy.

15. The apparatus as recited in claim 14, further comprising:
at least one detachable machine contact unit configured to transmit the energy to a handheld machine tool.

16. The apparatus as recited in claim 15, wherein the detachable battery contact unit and the detachable machine contact unit are configured in a complementary manner.

17. The apparatus as recited in claim 15, wherein the charging connection unit has an energy receiving coil.

18. The apparatus as recited in claim 15, wherein the detachable machine contact unit has a protective device which prevents energy absorption from a wire-bound charging device.

19. The apparatus as recited in claim 18, wherein the protective device prevents contacting of the wire-bound charging unit.

20. The apparatus as recited in claim 15, further comprising:
a monitoring electronics system configured to monitor at least one charging process.

21. The apparatus as recited in claim 15, further comprising:
a connecting element configured to connect at least one of the detachable battery contact unit, the detachable machine contact unit, and the charging connection unit on at least two different sides of the battery accommodation region.

22. The apparatus as recited in claim 15, wherein the charging connection unit at least partially encloses the handheld machine tool.

23. A system comprising:
a battery pack; and
a handheld-tool battery charging apparatus, including:
at least one battery accommodation region;
at least one detachable battery contact unit configured to be connected to the battery pack; and
at least one charging connection unit configured to receive wirelessly transmitted energy.

24. The system as recited in claim 23, wherein the handheld-tool battery charging apparatus is configured to remain connected to the battery pack when the battery pack is separated from a handheld machine tool.

25. A system comprising:
a handheld machine tool; and
a handheld-tool battery charging apparatus, including:
at least one battery accommodation region;
at least one detachable battery contact unit configured to be connected to the battery pack; and
at least one charging connection unit configured to receive wirelessly transmitted energy.

26. The system as recited in claim 25, wherein the handheld-tool battery charging apparatus is configured to remain connected to the handheld machine tool when the battery pack is separated from the handheld machine tool.
